(19) United States
(12) Patent Application Publication
(10) Pub. No.: US 2004/0089769 A1
(43) Pub. Date: May 13, 2004

(54) Device for fixing a functional member to a structural part of a motor vehicle, and a structural part including a portion of such a device

(75) Inventors: Pascal Carrier, Lyon (FR); Hugues Cheron, Meximieux (FR); Gerald Andre, Amberieu en Bugey (FR)

Correspondence Address: OLIFF & BERRIDGE, PLC, P.O. BOX 19928, ALEXANDRIA, VA, 22320, US

(73) Assignee: Compagnie Plastic Omnium, Lyon (FR)

(21) Appl. No.: 10/418,157

(22) Filed: Apr. 18, 2003

(30) Foreign Application Priority Data
Apr. 18, 2002 (FR) 0204888

(51) Int. Cl. F16B 15/00

(52) U.S. Cl. 248/71; 248/74.2; 248/316.7

(57) ABSTRACT

The present invention provides a device for fixing a functional member to a structural part of a motor vehicle, the device comprising:

a clamping spacer carried by the functional member;

a clip suitable for clamping on the spacer and capable of occupying an open position in which it releases the spacer and a closed position in which it holds it; and

a fixing housing carried by the structural part and suitable for containing the clip,

means for guiding the clip in the fixing housing enable the clip to be inserted in part in the fixing housing so as to leave it in its open position, and subsequently to continue with insertion of the clip into said fixing housing, with the guide means then acting on the clip to put it into its closed position. The invention also provides a structural part and an equipment front face for a motor vehicle.

The present invention relates to a device for fixing a functional member to a structural part of a motor vehicle, and also to a structural part including a portion of such a device.

### BACKGROUND OF THE INVENTION

The front structural part of a motor vehicle supports various functional members.

For example, an equipment front face is generally designed to support light units in its side portions and a cooling assembly in its central portion, i.e. a radiator and/or a fan unit and/or a condenser.

However, fixing such a cooling assembly raises handling problems since the fixing means normally used require special attention on the part of the operator and require the operator to perform movements that are tiring. To sum up, the operation of assembling the cooling assembly to the vehicle structure is lengthy and expensive.

### OBJECTS AND SUMMARY OF THE INVENTION

The present invention seeks to propose a fixing technique which, while being reliable, is also more convenient for fixing the functional member.

More specifically, the invention relates in particular to the problem of fixing a cooling assembly to the top portion of an equipment front face, where the position of the cooling assembly in the vertical direction, also referred to as its “Z position”, is imposed on the equipment front face by other fixing means.

For example, if the cooling assembly is fixed to the engine unit or is supported by a bottom cross-member forming part of the structure of the vehicle, then the equipment front face which is fitted to the vehicle independently of the cooling assembly can, because of the invention, provide means for fixing the top portion of the radiator.

The term “Z accommodation” is used to designate this option provided by the device of the invention for accepting an imposed vertical position for the functional member.

The present invention provides a device for fixing a functional member on a structural part of a motor vehicle, the device comprising a clamping spacer designed to be carried by the functional member, a clip suitable for clamping onto the spacer and capable of occupying an open position in which it frees the spacer and a closed position in which it holds it, a fixing housing carried by the structural part, suitable for containing the clip, guide means for guiding the clip in the fixing housing, enabling the clip to be inserted in part in the fixing housing and thus enabling it to be left in the open position, and subsequently enabling insertion of the clip into said fixing housing to be continued with the guide means then acting on the clip to put into its closed position.

By means of the invention, the functional member can be fixed “blind” to the structural part by leaving the clip open in its partially inserted position in the fixing housing and by engaging the clamping spacer in the open clip until the clamping spacer, now fully engaged in the clip, exerts thrust on the clip which inserts it fully in said fixing housing. The clip thus closes on the clamping spacer under drive from the fixing housing, and the functional member is fixed to the structural part.

Preferably, the clip is inserted into the housing by moving in translation along an insertion direction, and the spacer penetrates through the passage in the clip in the same insertion direction, such that engagement of the spacer in the clip and insertion of the clip take place in a single continuous movement in translation of the functional member.

In a particular embodiment of the invention, the guide means are slideways.

The slideways may be of various shapes, they seek to facilitate insertion of the clip in the fixing housing. In addition, the slideways may hold the clip relative to the fixing housing in a direction perpendicular to the insertion direction. In other words, with horizontal slideways, the clip is positioned both vertically and laterally in the fixing housing.

In order to facilitate insertion of the clip, a particular embodiment of the invention provides for the structural part to include, upstream from the fixing housing in the clip insertion direction, an approach zone that acts to center the clip.

By way of example, this can be constituted by a flared inlet to the housing, that is suitable for guiding said clip laterally so as to enable it to be fully inserted in the housing, but that is not suitable for acting sufficiently on the clip to close it.

In a particular embodiment of the invention, the device includes means for retaining the clip inserted in the fixing housing.

The retaining means prevent the clip from being moved at the end of insertion into the fixing housing, and this is independent of whether or not the spacer and the functional member are present.

Such means can be constituted, for example, by snap-fastening means.

In accordance with the invention, a spacer is designed to be carried by the functional member and to serve as a purchase for the clip.

In a preferred embodiment, the clip and the spacer are arranged in such a manner that the clip can clamp onto the spacer at different locations, thus enabling the spacer to take up different positions relative to the clip in a given direction.

This embodiment provides a solution to the Z accommodation problem as mentioned above, since the functional member can then have its vertical position imposed by its support, and said imposed vertical position determines the height of the spacer at the time it is presented to the clip in order to be clamped. Although this height varies from one vehicle to another, the clip clamps onto the spacer and blocks its Z position.

In a particular embodiment, the spacer serves as an abutment for the functional member in a given direction, e.g. vertically. For this purpose, the spacer bears against a bearing surface of the functional member and prevents it from moving in the corresponding direction.

The spacer may be integrated in the functional member, however it may also be fitted onto a purchase of said functional member. It then makes it possible to use the fixing device with functional members of any shape, since the clip need only match a particular shape of purchase.

By way of example, the spacer may be a block of elastically deformable material.

The ability of the spacer to deform makes it possible to accept a certain amount of offset between the position of the functional member and the structural part when said functional member is carried by some other support that determines its position. This possibility of accommodation relates essentially to the transverse direction, also referred to as the Y direction, in which the clip clamps onto the spacer, and is available only for offsets of a size that is very much smaller than the size available for accommodation in the Z direction.

As a comparative example, offsets that can be accommodated in the Y direction are half to one-third the offsets that can be accommodated in the Z direction.

With a functional member that is free in the Y direction, either because it is carried only by the fixing device of the invention, or because its other fastenings leave it this degree of freedom, the functional member becomes centered laterally by the spacer being clamped and by the ability of the spacer to deform to accommodate dispersions due to the manufacturing tolerances of the various parts involved.

The deformable material constituting the spacer is preferably a rubbery material, making it possible not only for it to act as a spacer, but also to absorb the vibration coming from the functional member or the structural part, and preventing such vibration being transmitted from one to the other.

In a particular embodiment of the invention, the purchase of the functional member is a pin and the spacer has an orifice for receiving said pin.

In addition, it is advantageous for the orifice in the spacer to be a slot in which the fixing pin can move on being subjected to thrust in excess of a predetermined threshold, since the functional member can then move relative to the structural part.

This disposition is advantageous under circumstances when the vehicle is subjected to an impact which moves the functional member relative to the front of the vehicle. With the invention giving the structural part a certain degree of freedom to move backwards relative to the structure in which it is fixed, the functional member or its fixing purchases can escape damage and can even avoid damaging the structural member.

The clamp used in the invention advantageously comprises two jaws capable of moving apart from each other and towards each other, preferably elastically.

The clip is thus elastically deformable, and at rest it takes up its open position.

In a particular embodiment, the clip has engagement shapes on one of its faces that comes into contact with the spacer. These shapes are preferably oriented so as to favor retention of the spacer in a particular direction, e.g. vertically, so as to enable said spacer to perform its function as an abutment for the functional member, and regardless of its position in a broad but predetermined tolerance range.

The invention also provides a motor vehicle structural part for supporting a functional member by means of a device as described above, the part including the fixing housing of said device.

The invention also provides a top cross-member for the front of a motor vehicle as a structural part, and an equipment front face for a motor vehicle including such a cross-member.

### BRIEF DESCRIPTION OF THE DRAWINGS

To make the invention easier to understand, there follows a description of an embodiment given by way of non-limiting example and with reference to the accompanying drawings, in which:

FIG. 1 is a three-quarters front perspective view of an equipment front face fitted with a cooling assembly;

FIG. 2 is a view of detail II of the FIG. 1 cooling assembly;

FIG. 3 is a view analogous to FIG. 2 showing a rubber spacer engaged on the radiator pin;

FIG. 4 is a perspective view of a fixing clip;

FIG. 5 is a front view of a housing for fixing the equipment front face;

FIG. 6 is a perspective view from beneath of the same fixing zone fitted with a clip;

FIG. 7 is a perspective view of the same fixing zone receiving the radiator fixing pin and the spacer; and

FIG. 8 is a perspective view from behind of the same fixing zone.

### MORE DETAILED DESCRIPTION

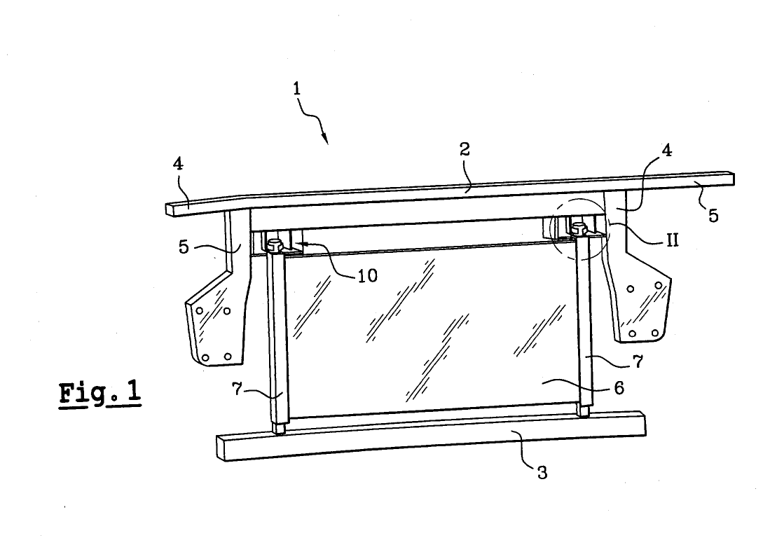

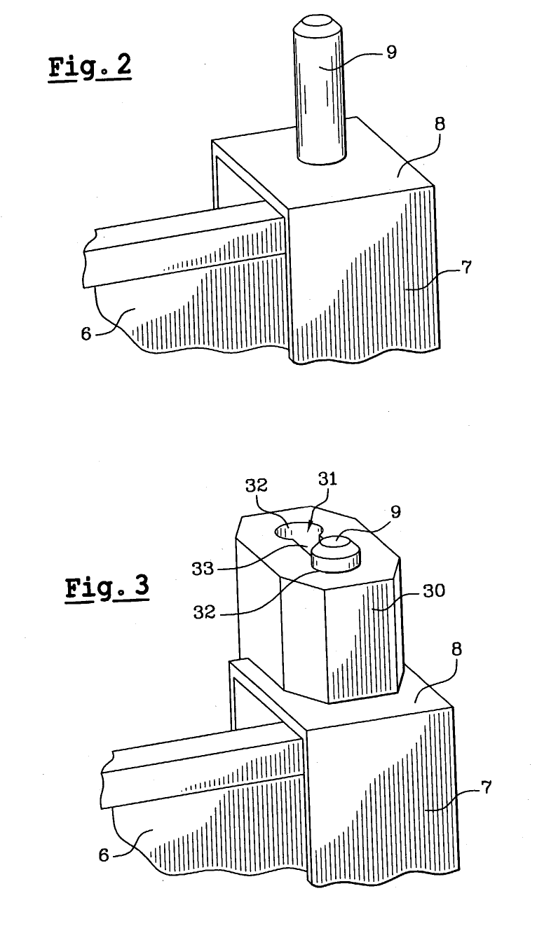

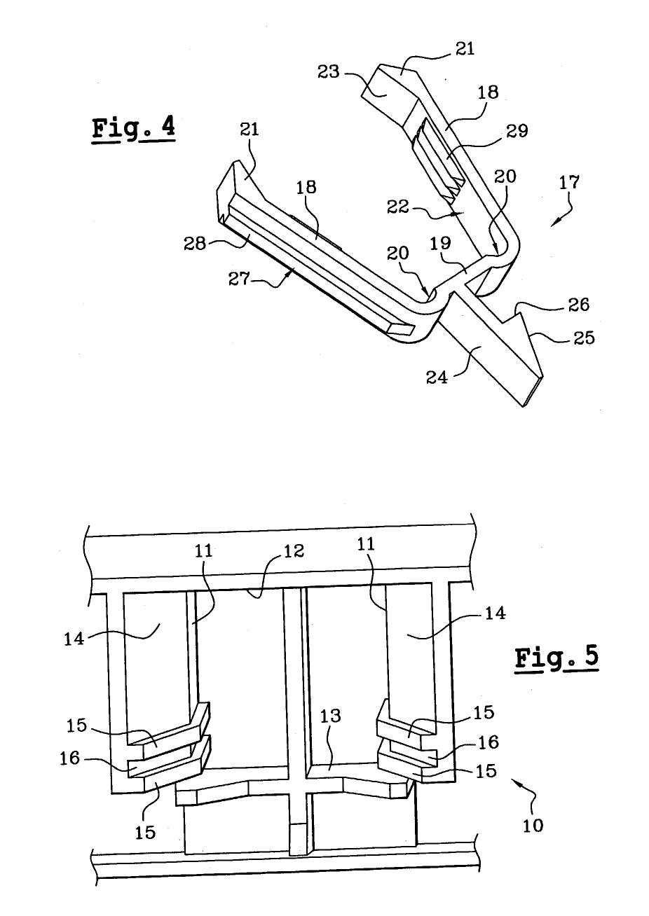

The equipment front face 1 shown in FIG. 1 is a structural part which is positioned at the front of the vehicle, above its bottom beam 3, and which includes a top cross-member 2, side support parts 4 and side legs 5.

In the context of the present description, only the top cross-member 2 is of interest, such that the example described below can be considered as applying to any structural part placed at the front of a vehicle and having a top cross-member. The structural part may indeed comprise no more than said cross-member.

A cooling assembly 6 is designed to be received vertically beneath the top cross-member 2, being supported and positioned vertically by bearing on the bottom cross-member 3, via fastener means (not shown).

In this case, the cooling assembly 6 comprises solely a radiator. In a variant, it could also include a condenser and/or a fan unit.

The radiator 6 supported by the bottom cross-member 3 is fixed to the top cross-member 2 by specific means that are described below.

The radiator 6 lies between two vertical branches 7, each of which is terminated by a top horizontal plate 8 (when the radiator is in its in-use position), which plate extends perpendicularly to the longitudinal direction of said branch.

Projecting from said plate 8, the frame 7 includes a vertical fixing pin 9 of generally cylindrical shape with a tapering end, which provides purchase enabling the radiator to be secured to the top cross-member.

The cross-member 2 is provided with two fixing housings 10 each situated facing a fixing pin 9 of the radiator 6.

Each fixing housing 10 of the cross-member is a compartment of rectangular cross-section defined by two side walls 11, a top wall 12, and a bottom wall 13.

The two side walls 11 are parallel to each other, but they are extended forwards in the form of two diverging vertical planes 14 which define between them an approach zone situated upstream from the fixing housing 10.

The top wall 12 of the housing is extended as far as the approach zone.

Each of the diverging side walls 14 of the approach zone, and of the parallel walls 11 of the fixing housing 10 is provided with two respective ribs 15 defining between them a guide rail 16.

Each guide rail 16 may be formed integrally with the cross-member 2 if the cross-member is obtained by molding a plastics material, however it could equally well be fitted to the side walls of the fixing housing and of the approach zone.

In the approach zone, the two guide rails 16 approach each other going towards the fixing housing 10. Inside the fixing housing they are parallel.

The fixing housing, provided with the rails, is designed to receive a clip 17 of low friction flexible material, and as shown in FIG. 4.

In this Figure, the clip 17 is shown at rest. It comprises two jaws 18 that are symmetrical to each other about a midplane, and that are united by a connection strip 19 which is at an angle with each of the two jaws 18.

The connection between the connection strip 19 and each jaw 18 is shaped with a rounded setback 20 which serves as a hinge making it easier to close the clip by moving the two jaws 18 towards each other.

The free end of each jaw carries a retaining edge 21 projecting from its inside wall 22. On the inside of the clip, the retaining edge 21 presents a plane face 23 forming an obtuse angle with the inside face 22 of the jaw, and thus partially enclosing the space defined between the two jaws.

Thus, at rest, the clip leaves an empty passage between its two retaining edges 21, while in the closed position, its two retaining edges 21 obstruct the passage.

In addition, the clip 17 has a snap-fastening tab 24 on the face of the connection strip 19 facing away from the jaw. This snap-fastening tab 24 is formed by a tongue provided with a chamfer 25 and a shoulder 26 enabling the tongue to catch on a bearing surface in order to retain the clip axially at the end of insertion.

The snap-fastening tab 24 and the bearing surface 34 constitute retaining means in the meaning of the invention.

The outside faces 27 of the two jaws 18 are provided with respective ribs 28 dimensioned to be capable of engaging in the rail 16 in the approach zone and in the fixing housing of the cross-member.

In addition, the distance between the outside faces 27 of the two jaws, in the vicinity of the connection strip 19 is very slightly less than the distance between the rails 16 in the fixing housing 10.

Thus, it will be understood that the clip 17 can be engaged in the fixing housing 10 with each rib 28 of a jaw sliding in the corresponding rail 16 of the approach zone and then in the fixing housing.

Furthermore, the inside face 22 of each jaw comprises, in its central region, engagement shapes 29 constituted in this case by fluting parallel to said jaws.

The flare angle of the two jaws 18 at rest is slightly greater than the flare angle of the diverging sides walls 14 of the approach zone.

Thus, the clip 17 can be positioned in the approach zone, in which it is retained either by friction between the outside faces 27 of the jaws against the rails 16, given the resilience of the clip, or because of a small amount of relief (not visible in the drawing) formed on the bottom of one of the rails or both rails 16 in the entrance to the approach zone, said portion in relief forming a point of resistance that the clip needs to be forced past while it is being inserted into the approach zone.

When arranged in this way, the clip 17 retains its open position. It is considered as being partially inserted in the fixing housing 10.

As can be seen in FIG. 3, the fixing pin 9 of the radiator 6 receives a spacer constituted by a substantially cylindrical rubber block 30 having an octagonal base. This rubber block 30 is pierced axially by a through slot 31 whose cross-section is substantially oblong, having circular ends 32 of the same diameter as the radiator fixing pin 9 and a rectangular connection zone 33 of width smaller than the diameter of the circular ends 32.

This special section for the slot 31 has the consequence that the rubber block 30 holds the fixing pin 9 in one or other of the cylindrical ends 32 of the slot and opposes passage of the pin through the connection zone 33. In other words, only a force greater than a certain threshold can force the fixing pin 9 to leave the cylindrical end 32 in which it is to be found.

In order to obtain the desired effect, it may be observed that it is not essential for the slot to be symmetrical as described above, with this being described below. Nevertheless, this symmetry presents certain practical advantages in manufacture of the spacer and in installation thereof on the radiator pin, since it does not need to be oriented in any particular direction.

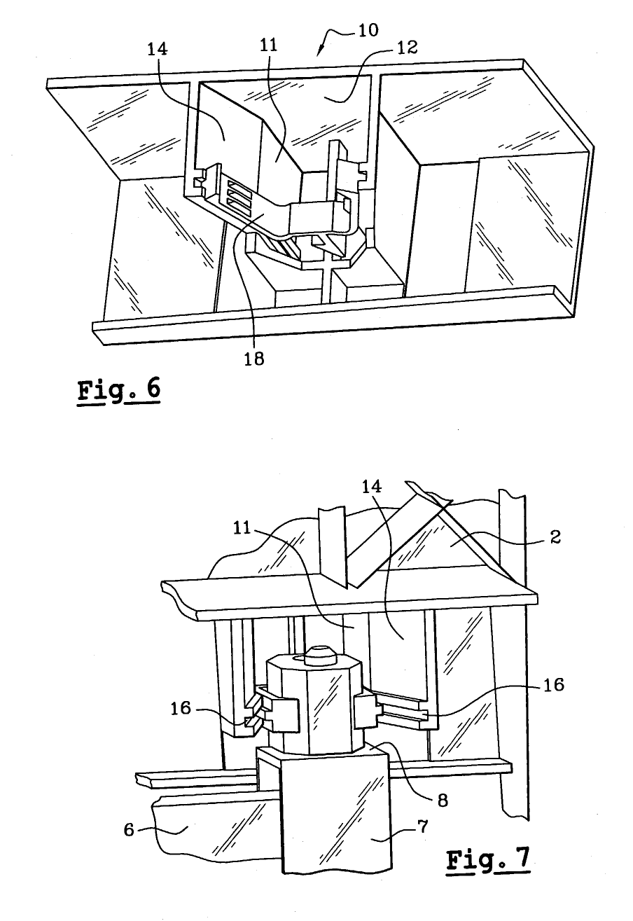

Referring to FIG. 6, it can be seen that the open clip 17 housed in the approach zone can receive the spacer 30 engaged on the fixing pin 9 of the radiator.

With the radiator 6 presented before the equipment front face 1 in the position shown in FIG. 1, the top portion of the radiator is caused to move in translation towards the equipment front face in the longitudinal direction of the vehicle.

This movement in translation may be perfect in the sense that the radiator is moved parallel to itself along the direction X, or approximate, if the radiator is previously at an angle on the bottom beam which supports it, and is then subjected to pivoting that returns it to the vertical position under the top cross-member, the top portion of the radiator then moving in a way that can be considered as being in translation.

The two spacers 30 carried by the radiator 6 are then inserted between the jaws 18 of the open clips.

If the radiator is free transversely, either because it has not yet been blocked laterally on the bottom beam, or because its fasteners on the bottom beam leave it a degree of freedom in the transverse direction, then the spacers center the radiator relative to the top cross-member.

In contrast, if the lateral position of the radiator is determined by its fastening to the bottom beam, then the spacers deform so as to accommodate the small amount of offset that exists within the tolerance ranges between said imposed position and the locations of the housings.

In both circumstances, the spacers deform in order to absorb the distance offset between the two housings on the cross-member and the two pins on the radiator.

Each spacer 30 then comes into abutment against the connection strip 19 of the corresponding clip.

By continuing to move the radiator in translation, a force is exerted on the connection strips 19 of the clips, thereby causing them to slide along the rails 16 and inserting the clips in the fixing housings 10.

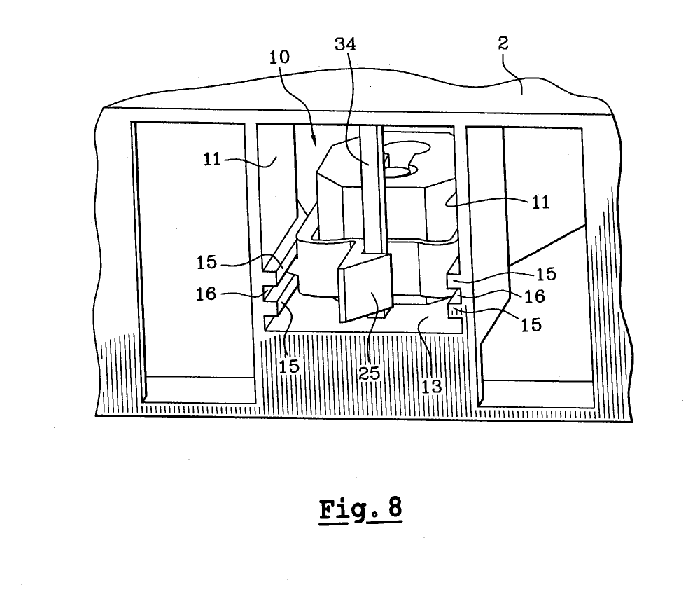

Simultaneously, the jaws 18 of the clip, which are constrained by the side walls 11 of the fixing housings 10, close on the rubber blocks 30 until they reach the position shown in FIG. 7, in which it can be seen that the two jaws 18 of each clip have become mutually parallel and that their ends 21, now closed on the rubber block 30, prevent it from coming out.

At the bottom of the fixing housings 10, the snap-fastening tab 24 of each clip 17 engages the snap-fastening bearing surface 34 which in this case is constituted by a vertical bar interconnecting the bottom and top walls 13 and 12 of the fixing housing 10.

Because of its chamfer 25, the tongue 24 begins by moving away from the vertical bar 34. On reaching the end-of-stroke position, the chamfer 25 has gone past the vertical bar and the shoulder 26 of the tongue comes to bear against the vertical bar 34, thus snap-fastening the clamp in the housing.

At this stage, it can be seen that it is advantageous for the octagonal section of the rubber block 30 to correspond substantially to the inside section of the clip 17 when in its closed position, i.e. when its jaws 18 are parallel to each other.

The engagement fluting 29 on the inside walls 22 of the jaws penetrate into the facing walls of the rubber block 30 and prevent it from moving vertically, the clip 17 itself being prevented from moving vertically on the cross-member 2 by means of the rails 16.

Thus, each rubber block is held stationary in the cross-member under the following conditions:

in the X direction, it is positioned by the clips coming into abutment against the ends of the housings and it is blocked in this position;

in the Y direction, it is positioned if the fastenings with the bottom beam makes this possible, as explained above, and it is blocked in this position; and

in the Z direction, it is merely blocked, positioning being imposed by the bottom beam. This blocking is the result of the spacers 30 bearing against the plates 8.

The rubber spacers 30 thus serve to retain the radiator 6 on the cross-member 2 with longitudinal positioning that is accurate, while also providing insulation against vibration.

It can be seen that the radiator can be fixed to the cross-member simply and “blind”, i.e. the operator does not need to perform prior centering nor is there any need to operate any kind of locking member, locking taking place automatically merely under thrust from the radiator.

It can also be seen that this fixing takes account of a vertical position of the radiator as determined by the bottom beam which is external to the equipment front face. This Z direction accommodation is made possible by the cylindrical shape of the spacer, which enables the clip to clamp onto the spacer regardless of the height at which it is presented.

The radiator positioned in this way on the top cross-member can still move backwards without damage, for example in the event of a low energy frontal impact.

This possibility is the result of the shape of the slot 31 in each spacer 30 which makes it possible, on receiving sufficient thrust, for the fixing pin 9 to leave the end 32 of the slot.

It suffices to place the spacer 30 on the pin 9 in such a manner that the pin is at the front end 32 of the slot (the end furthest from the cross-member at the time of radiator assembly) so that subsequently, in the event of an impact, the fixing pin 9 can overcome the friction forces opposing displacement thereof along the slot and can move to the rear end of the slot.

The nature and the hardness of the rubber constituting the spacer, the precise dimensions of the slot and of the pin, and the clamping force of the clip on the spacer are determined by the minimum force required by the manufacturer's specifications in terms of frontal impact.

Similarly, the length of the cross-section of the slot determines the rearward stroke that the radiator can travel without damage.

Beyond that stroke, the clip 17 is destroyed, but it is easily replaced at low cost.

Naturally, the embodiment described above is not limiting in any way, and can receive any desirable modification without thereby going beyond the ambit of the invention.

In particular, the guide rails described in the housings may be carried by the clips, in which case the housings may carry ribs.

What is claimed is:

1/ A device for fixing a functional member on a structural part of a motor vehicle, the device comprising a clamping spacer designed to be carried by the functional member, a clip suitable for clamping onto the spacer and capable of occupying an open position in which it frees the spacer and a closed position in which it holds it, a fixing housing carried by the structural part, suitable for containing the clip, guide means for guiding the clip in the fixing housing, enabling the clip to be inserted in part in the fixing housing and thus enabling it to be left in the open position, and subsequently enabling insertion of the clip into said fixing housing to be continued with the guide means then acting on the clip to put into its closed position.

2/ A device according to claim 1, in which the clip is inserted into the housing by moving in translation along an insertion direction, and in which the spacer penetrates through the passage in the clip in the same insertion direction.

3/ A device according to claim 1, in which the guide means are slideways.

4/ A device according to claim 1, in which the structural part has an approach zone upstream from the fixing housing in the insertion direction of the clip, thus enabling the clip to be centered.

5/ A device acorn to claim 1, including retaining means enabling the clip to be prevented from moving at the end of its insertion stroke into the fixing housing.

6/ A device according to claim 5, in which the retention means are snap-fastening means.

7/ A device according to claim 5, in which the clip comprises two jaws united by a connection strip whose face opposite from the jaws carries the retaining means.

8/ A device according to claim 1, in which the clip and the spacer are arranged in such a manner that the clip can clamp onto the spacer at different locations, thus enabling the spacer to occupy different positions relative to the clip in a given direction.

9/ A device according to claim 1, in which the spacer serves as an abutment for the functional member in a given direction, e.g. vertically.

10/ A device according to claim 1, in which the spacer is a block of elastically deformable material.

11/ A device according to claim 10, in which the deformable material constituting the spacer is preferably a rubbery material.

12/ A device according to claim 1, in which the spacer has an orifice for receiving a fixing pin secured to the functional member.

13/ A device according to claim 12, in which the orifice in the spacer is a slot in which the fixing pin can move when it is subjected to thrust greater than a predetermined threshold.

14/ A device according to claim 1, in which the clip is elastically deformable and occupies its open position when at rest.

15/ A device according to claim 1, in which the clip includes engagement shapes on one of its faces that comes into contact with the spacer.

16/ A device according to claim 1, in which the structural part is a top cross-member at the front of a motor vehicle.

17/ A device according to claim 1, in which the structural part is a top cross-member of an equipment front face of a motor vehicle.

18/ A motor vehicle structural part for supporting a functional member by means of a device according to claim 1, the part including the fixing housing of said device.

19/ A top cross-member for the front of a motor vehicle as a structural part according to claim 18.

20/ An equipment front face for a motor vehicle including a cross-member according to claim 19.
